(19) United States
(12) Patent Application Publication
(10) Pub. No.: US 2013/0341431 A1
(43) Pub. Date: Dec. 26, 2013

(54) Drip Emitter with Outlet Tube

(71) Applicants: Mark M. Ensworth, Orange, CA (US); Berj Zakarian, Redlands, CA (US)

(72) Inventors: Mark M. Ensworth, Orange, CA (US); Berj Zakarian, Redlands, CA (US)

(21) Appl. No.: 13/800,354

(22) Filed: Mar. 13, 2013

Related U.S. Application Data
(60) Provisional application No. 61/662,272, filed on Jun. 20, 2012.

(51) Int. Cl. A01G 25/02

(52) U.S. Cl. CPC A01G 25/023
USPC 239/542

(57) ABSTRACT

A dripline with outlet tubes for drip emitters is provided to direct water flow discharging from the dripline to aid in even water distribution to surrounding soil and plants. The outlet tubes extend away from the dripline and may be preassembled with the dripline during manufacture to facilitate ease of installation.

### CROSS REFERENCE TO RELATED APPLICATION

This patent application claims benefit to U.S. Provisional Application No. 61/662,272, entitled “Drip Emitter with Outlet Tube” and filed on Jun. 20, 2012, the content of which is incorporated herein by reference in its entirety.

### FIELD

This invention relates to the design of a dripline and, more particularly, to an improved outlet for drip irrigation emitters to increase dripline effectiveness.

### BACKGROUND

Drip irrigation is commonly used to supply irrigation to landscaping and crops. Drip irrigation emitters are generally known in the art for use in delivering irrigation water to a certain area at a predetermined and relatively low flow rate, thereby conserving water. The drip emitter taps a portion of the relatively high pressure irrigation water from a supply tube, such as a dripline, for flow through a typically long tortuous flow duct path to achieve a desired pressure drop prior to discharge at a target trickle or drip flow rate.

In a conventional system, a large number of drip emitters are mounted at selected positions along the length of the irrigation supply tube to deliver the irrigation water to a large number of specific points, such as directly to a desired spacing for effective coverage or to a plurality of individual plants. More specifically, a number of drip emitters are fitted into a conduit and spaced apart at appropriate distances depending on the desired irrigation output. Each emitter includes an inlet to receive water flowing through the conduit, an outlet to emit water from the conduit at a specific, controlled rate for irrigation, and a body member intermediate the inlet and the outlet that defines the flow duct path.

The controlled flow rate is important to insure that water is evenly distributed to the desired area and plants. However, experience has shown that when the dripline conduit is on an incline, for example with vineyard applications, the water discharging from the dripline tends to cling to the outside of dripline rather than flow away from the emitter and dripline to the surrounding area and plants. The water sticks to the dripline since the water molecules are more attracted to the surface of the dripline than they are to each other due to the covalent nature of water. This is undesirable because as the water flows along the outer surface of the dripline, the plants farther from the dripline outlet and farther down the incline in general will tend to receive more water than those towards the top of the incline.

A known attempt to counteract the tendency of the water to flow along the outer surface of the dripline is to attach a collar around the dripline after every emitter opening or at least those on the inclined terrain. The collar would interrupt any water flowing along the dripline and deflect it away from the dripline. This forces the water to flow onto the surrounding area and plants rather than allowing it to travel down the dripline for a while before flowing onto the ground. While this solution accomplishes redirecting the water flow, it is expensive and labor intensive to implement. For instance, each collar must be manually fit onto a dripline after each emitter, and given a large installation, this generates a significant amount of additional labor and material costs. Thus, there is a desire for an improved emitter that improves the effectiveness of a dripline and reduces the costs and labor required for an installation.

### BRIEF DESCRIPTION OF THE DRAWINGS

FIG. 1 is a perspective view of a dripline with an outlet tube;

FIG. 2 is an end view of the dripline of FIG. 1;

FIG. 3 is a cross-sectional view of the dripline of FIG. 2 taken along line A-A of FIG. 2;

FIG. 3A is a cross-sectional view of the dripline of FIG. 2 taken along line A-A of FIG. 2 showing an alternative outlet tube;

FIG. 3B is a cross-sectional view of the dripline of FIG. 2 taken along line A-A of FIG. 2 showing another alternative outlet tube;

FIG. 4 is an exploded top perspective view of the drip emitter of FIG. 1;

FIG. 5 is a perspective view of an alternative embodiment of the drip emitter of FIG. 1 with a barbed outlet tube;

FIGS. 6A, 6B, and 6C are a cutaway views of alternative outlet tube configurations; and

FIG. 7 is a perspective view of an alternative single-piece emitter.

### DESCRIPTION OF THE PREFERRED EMBODIMENTS

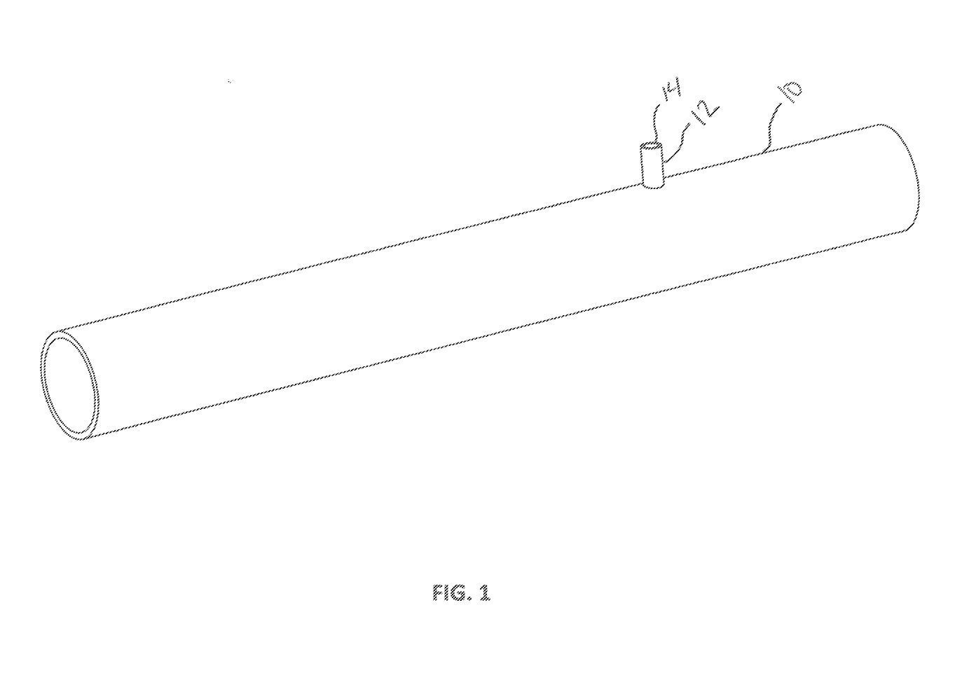

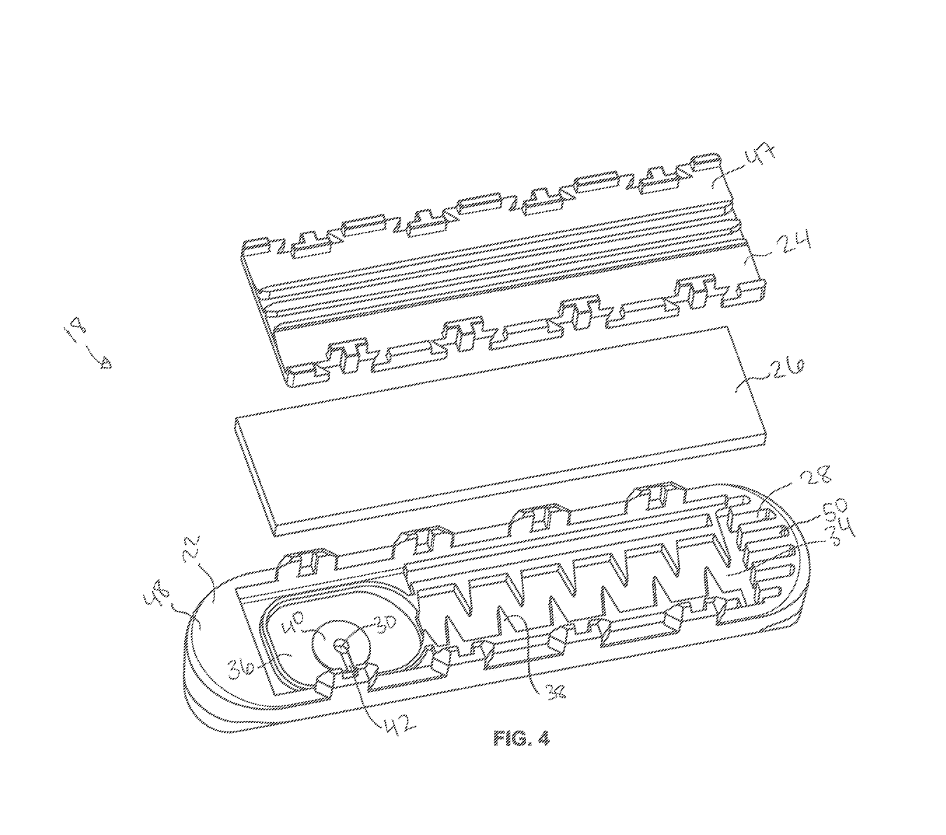

Referring to FIGS. 1-4, an irrigation dripline 10 is shown with an emitter outlet tube 12 extending outward. The outlet tube 12 terminates with an outlet 14 spaced from the dripline 10. The outlet tube 12 carries water away from the dripline 10 so that the water discharging from the outlet 14 will not cling to the dripline 10 and flow along the dripline 10 away from the area and plants that it is supposed to irrigate. The dripline 10 is preferably preassembled with the outlet tube 12, which drastically reduces the material costs and amount of labor required to install a dripline system because additional fittings, such as collars, do not have to be installed to deflect the water.

The outlet tube 12 is illustrated with a cylindrical shape with a circular cross-section. Other shapes and cross-sections, such as conical, square, rectangular, triangular etc., are contemplated. The length of the outlet tube 12 is long enough to space the outlet 14 from the dripline 10 such that the discharged water will not be in a position to cling to the dripline 10. It also may be long enough to attach a lateral line. For example, it may be appropriate for the outlet tube 12 to be 0.125 to 0.5 inches long. The outlet tube also may have an outer diameter suitable for attachment of a lateral line. For example, it may have an outer diameter in the range of 0.125 to 0.25 inches. The inner diameter may be around 0.05 to 0.20 inches. The outlet tube 10 receives water from a drip emitter located inside the dripline 10. The drip emitter reduces the pressure in the dripline so that a low volume or drip is discharged from the outlet tube 10. The drip emitter can also be either a non-pressure compensating or a pressure-compensating drip emitter.

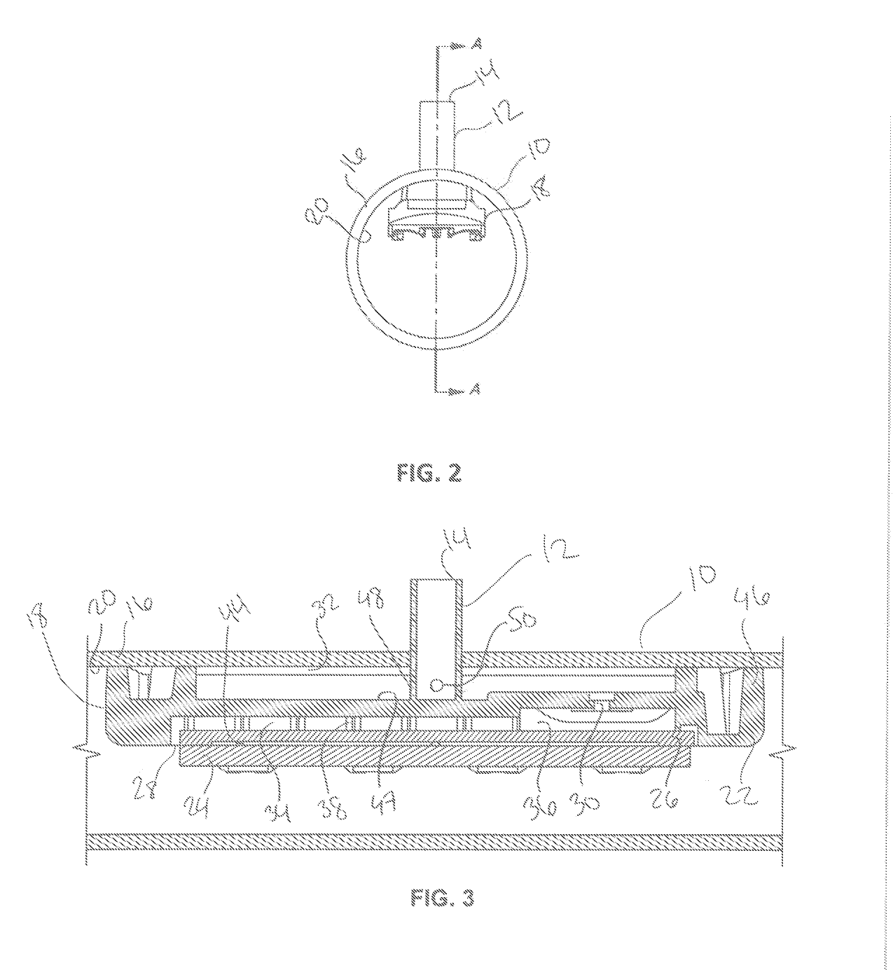

More specifically, a series of drip emitters are affixed inside the dripline 10 to a wall 16 of the dripline 10 to discharge water at desired locations. The spacing between the emitters may depend on the desired application for the dripline 10. A typical spacing is about 36 inches between adjacent emitters. One type of drip emitter suitable for use with the outlet tube 12 is illustrated in FIGS. 2, 3 and 4 as emitter 18. Emitter 18 is shown mounted to an inside surface 20 of the wall 16 of the dripline 10.

The emitter 18 has a generally rectangular body and includes a housing 22 and a cover 24. The housing 22, the cover 24 and outlet tube may be plastic molded components and may be molded from polyethylene. Alternatively, the components may be made of an elastomeric material, such as a thermoplastic or thermosetting elastomeric material like materials that use ethylene, propylene, styrene, PVC, nitrile, natural rubber, silicone, etc., to form a polymer or copolymer. In a preferred form, the elastomeric material may be made from thermoplastic polyolefin (TPO) and silicone rubber.

The housing 22 and the cover 24 are adapted for easy assembly and define a substantially enclosed housing interior. A diaphragm 26 is disposed in the interior of the housing 22 interior between the housing 22 and the cover 24. The housing 22 and the cover 24 may be secured together by gluing, welding and/or a mechanical interconnection, such a snap fit.

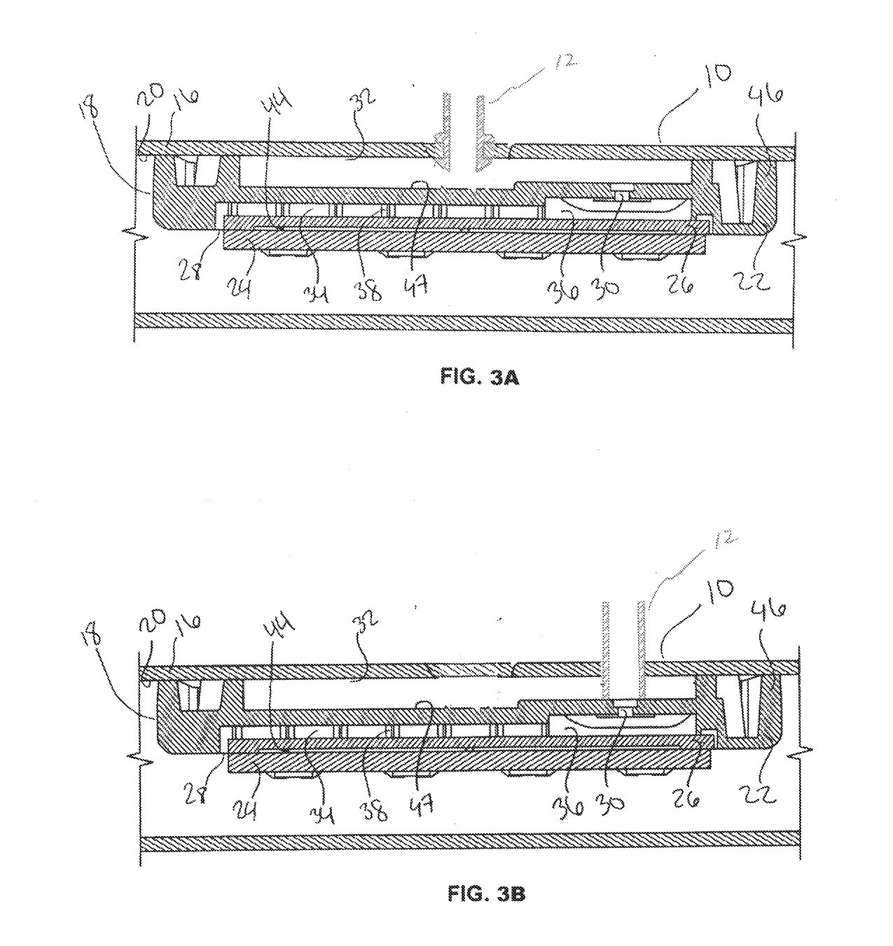

The emitter 18 includes an inlet 28 to receive water from the dripline 10 and an outlet 30 to discharge water from the emitter 18. The inlet 28 may consist of a number of ports sized to provide the appropriate intake of water collectively but small enough individually to prevent foreign debris from entering the emitter 18. The outlet 30 discharges water into an outlet bath 32 formed between the housing 22 and the inside surface 20 of the wall 16 of the dripline 10. The outlet tube 12 receives water from the outlet bath 32. Alternatively, the outlet 30 could discharge directly to the outlet tube 12, as illustrated in FIG. 3B. This would avoid the use of the outlet bath 32.

A pressure reducing path connects the inlet 28 and the outlet 30. More specifically, the pressure reducing path includes a tortuous path 34 and a metering chamber 36 defined by the housing 22 and the diaphragm 26. The diaphragm 26 is preferably an elongated strip dimensioned to overlap and seal against the tortuous path 34 and the metering area 36 and is preferably a silicone or rubber material.

The tortuous path 34 includes two series of opposing baffles 38 that form the tortuous path 34 with a zigzagging configuration. The metering chamber 36 includes a metering surface 40 that defines a metering groove 42.

Water entering from the dripline 10 through the inlet 28 first flows through the tortuous path 34 and then into the metering chamber 36. Once in the metering chamber 36, the water then flows through the groove 42 defined by the water metering surface 40 on the bottom of the watering meter chamber 36 to the emitter outlet 30. Water flowing through this flow path experiences a pressure drop.

The diaphragm 26 overlays the tortuous path 34 and the metering chamber 36 and alters the size of tortuous path 34 and the metering chamber 36 to compensate for change in water pressure in the dripline 10. More specifically, in addition to flowing into the tortuous path 34, water from the inlet 28 also flows into a pressure regulating chamber 44 formed in the cover 24 on the side of the diaphragm 26 opposite of the tortuous path 34 and the metering chamber 36. So, when then the water pressure increases, water flowing from the inlet 28 into the pressure regulating chamber 44 causes the diaphragm 26 to deflect into the tortuous path 34 and the metering chamber 36 to further constrict the tortuous path 34 and the metering chamber 36 to cause a further reduction in pressure across the emitter 18.

The outlet 30 of the emitter 18 discharges into the outlet bath 32 formed between the housing 22 and the inside surface 20 of the wall 16 forming the dripline 10. More specifically, the housing 22 defines the outlet 30, which is located at the opposite end of the emitter 18 as the inlet 28. The housing 22 also preferably includes a raised rim 46 extending about its perimeter. The raised rim 46 is used to mount the emitter 18 to the inside surface 20 of the dripline 10 by acting as an attachment zone. During assembly, the raised rim 46 is pressed into sealing engagement with the inside surface 20 of the dripline 10, as shown in FIG. 3, as the dripline 10 is being formed around the inserted emitter 18. The raised rim 46 forms a gap between a surface 47 of the housing 22 inside the raised rim 46 and the inside surface 20 of the wall 16 of the dripline 10. The gap forms the outlet bath 32 for the discharge of water from the outlet 30 of the emitter 18.

The outlet tube 12 extends from the outlet bath 32 through the wall 16 to the outside of the dripline 10. The outlet tube 12 includes a base 48 defining one or more inlet ports 50 to the outlet tube 12. The inlet ports 50 may be circular and sized large enough to permit any grit or other foreign debris that passes into the outlet bath 32 to be discharged from the emitter 18. The outlet tube 12 may be molded as a single piece with the housing 22 or may be molded separately and welded or glued to the housing 22. Alternatively, the outlet tube 12 could be attached to the housing 22 directly over outlet 30, as illustrated in FIG. 3B. In such a configuration, inlet ports 50 would not be required.

In another embodiment, the outlet tube 12 could be mechanically attached and/or welded or glued to the dripline 10. In FIG. 3A, one end of the outlet tube is configured with an annular groove 33 that receives the side wall of the dripline 10.

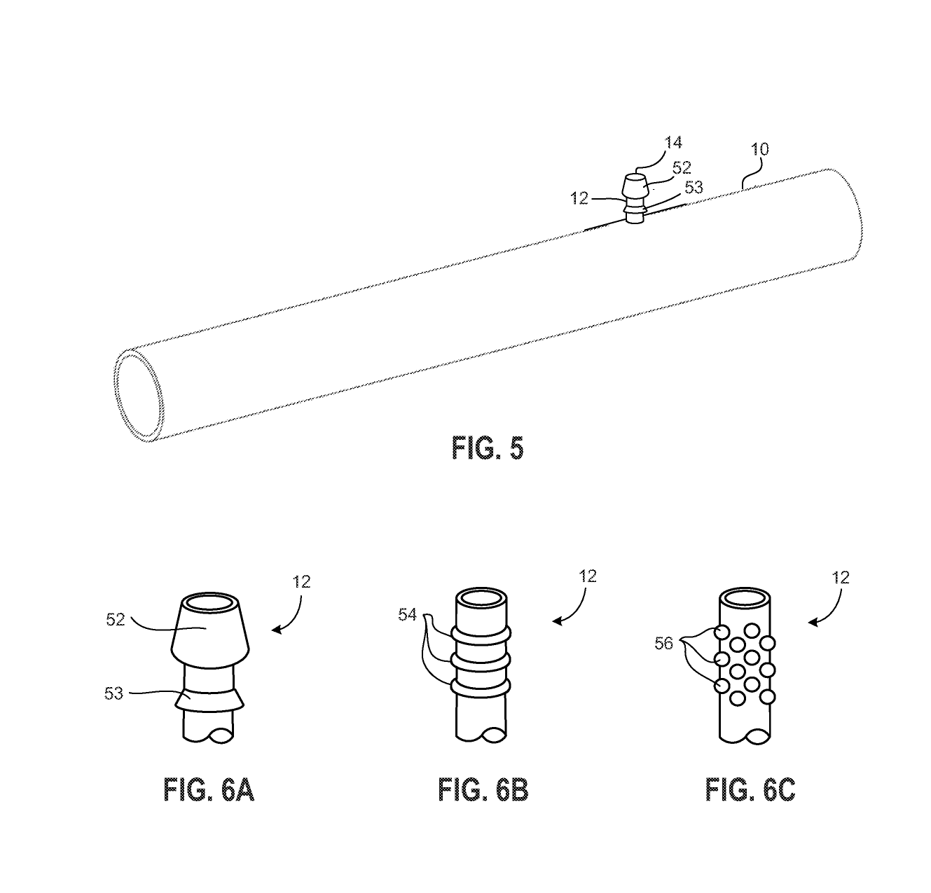

In an alternative embodiment shown in FIG. 5, the outlet tube 12 could have one or more barbs 52, 53 as the case requires. The primary barb 52 is sized to provide grip on an attached lateral line, such as a ¼″ transfer tube, and strengthen the transfer tube's connection to the emitter 18. The secondary barb 53 may be smaller than the primary barb 52 and provides additional connection strength. Alternative configurations of the outlet tube 12 to provide grip on a dripline are shown in FIGS. 6A, 6B, and 6C. FIG. 6A shows the before mentioned configuration utilizing the primary 52 and the secondary barb 53. FIG. 6B shows the tube 12 with ribbing 54 to provide grip on a transfer tube. FIG. 6C shows the tube 12 with protrusions 56 to provide a textured grip on a transfer tube.

The emitter 18 is preferably inserted into the dripline 10 during the extrusion process for the dripline 10. If the outlet tube 12 is attached to the housing 22, it would create a bulge during the extrusion process, and a cutter may be used to cut off the tip of the outlet tube 12 in a manner that maintains the desired length. The cutting of the tip creates the opening 14 and allows the wall 16 of the dripline 10 to constrict back toward the base of the outlet tube 12 and around the outlet tube 12 to seal against it. Alternatively, the outlet tube 12 may be added after the emitter 18 is installed in the dripline 10. For example, the dripline 10 may be drilled at the outlet bath 32 and the outlet tube 12 may be inserted and mechanically attached and or glued or welded to the dripline 10.

Additional description of the emitter 18 is in U.S. application Ser. No. 11/394,755, filed on Mar. 31, 2006 and published as U.S. Patent Application Publication No. 2006/0237561 on Oct. 26, 2006, both of which are hereby incorporated by reference. Many different emitter designs could include the outlet tube. For instance, other examples of emitters that can adopt the outlet tube are disclosed in U.S. application Ser. No. 13/430,308 filed on Mar. 26, 2012, U.S. application Ser. No. 12/436,394 filed on May 6, 2009 and published as U.S. Patent Application Publication No. 2010/0282873 on Oct. Nov. 11, 2009, and U.S. Pat. No. 7,648,085 issued on Jan. 19, 2010, all of which are hereby incorporated by reference.

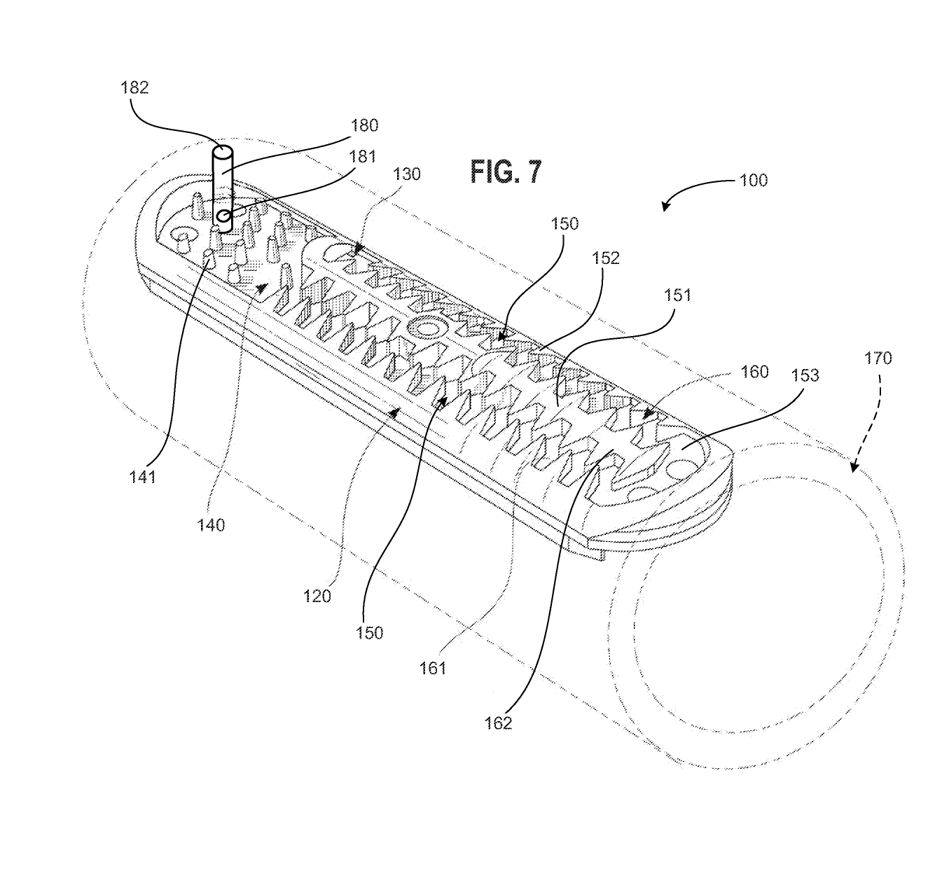

Another example of a pressure compensating emitter is the single piece emitter illustrated in FIG. 7. In this embodiment, an emitter 100 includes an integral body 120 which defines an inlet 130 connectible to a source of pressurized fluid, an outlet 140 with an exit tube 180 for discharging the fluid from the emitter body 120, and a pressure reducing flow channel or passage 150 between the inlet 130 and outlet area 140 for reducing the flow of fluid discharged through the outlet 16. In addition, the emitter body 120 defines a pressure compensating member 160 for reducing a cross-section of the flow channel in response to an increase in pressure of the pressurized supply line fluid.

In the form illustrated, the emitter body 120 is made of an elastomeric material, such as a thermoplastic or thermosetting elastomeric material like materials that use ethylene, propylene, styrene, PVC, nitrile, natural rubber, silicone, etc., to form a polymer or copolymer. In a preferred form, the elastomeric material is made of thermoplastic polyolefin (TPO) and silicone rubber. This combination helps create an emitter and dripline that is capable of withstanding the high temperatures and harsh chemicals the emitter may be subjected to while in use. In addition, the emitter is made of a singular or unitary construction rather than having a multi-part construction and/or requiring the assembly of housing parts, diaphragms, etc.

Fluid passes through the inlet opening 130 and enters a pressure-reducing flow channel 150 that produces a significant reduction in pressure between the fluid flowing in a primary lumen of the supply conduit or a dripline 170 and the fluid emptying into and present in the emitter outlet area 140. From the outlet area 140, the fluid enters an outlet tube 180 and flows out of the emitter 100.

In the form illustrated, the emitter body 120 defines opposed baffle walls to create the pressure-reducing flow channel and, in a preferred form, has an inner baffle wall 151 that is surrounded by an outer baffle wall 152 which extends about the inner baffle wall 151 in a generally U-shaped manner to form a flow passageway that generally directs the water in a U-shaped direction of travel. More particularly, the inner and outer baffle walls 151, 152 have alternating projections and recesses that form a tortuous passage and cause the fluid flowing therethrough to zigzag back and forth, reducing pressure with each turn the fluid makes. The outer baffle wall 152 is defined by an outer rim or peripheral wall of the emitter body 120 and the inner baffle wall 151 extends from a portion of the outer rim or peripheral wall and into to the middle of the emitter body 120 to form a peninsula about which the fluid flows from inlet 130 to outlet 140. The upper surfaces of the emitter body preferably have a radius of curvature that tracks the radius of curvature of the tube 170 so that the emitter body 120 can be bonded securely to the inner wall of the tube 170 and create an enclosed pressure reduction passage from inlet 130 to outlet 140. In the form illustrated, the tortuous passage is formed via alternating teeth extending from opposing surfaces of the inner and outer baffle walls 151, 152 and has a cross-section that is generally rectangular in shape when the emitter body 120 is bonded to the inner surface of the extruded dripline 170 (keeping in mind that the radius of curvature of the tube 170 will likely make the upper portion of the cross-section slightly curved and the side walls to be slightly wider at their top than at their bottom).

It should be understood, however, that in alternate embodiments the pressure-reducing flow channel 150 may be made in a variety of different shapes and sizes. For example instead of having projections with pointed teeth, the baffles could be made with blunt or truncated teeth, with teeth that are angled or tapered, with curved or squared projections instead of triangular shaped teeth, with projections of other geometrical shapes or geometries, symmetric or asymmetric, etc.

In addition to the pressure-reducing flow path 150, the emitter 10 further includes a pressure compensating feature 160 which further allows the emitter 10 to compensate for increases in fluid pressure in the primary lumen of the tube 170. More particularly, pressure compensating feature 160 allows the emitter 10 to maintain relatively constant outlet fluid flow and pressure even though the inlet fluid pressure may fluctuate from time-to-time. In the form illustrated, the pressure compensating feature 160 is a two part pressure compensation mechanism that comprises an elastomeric portion 161 capable of deflecting under pressure to reduce the cross-section of the pressure-reducing flow channel 150 and regulate fluid flow through the emitter, and a movable baffle portion 162 capable of changing the length of the flow channel to compensate for changes in supply line 170 fluid pressure.

The elastomeric portion 161 being a deflectable portion of the emitter body 120 that is moveable between a first position wherein at least a portion of the pressure-reducing flow channel 150 is of a first cross-section and a second position wherein the at least a portion of the pressure-reducing flow channel 150 is of a second cross-section, smaller than the first cross-section to regulate fluid flow through the emitter. In the form illustrated, the floor 161 of the flow channel 150 forms an elastomeric portion and raises and lowers in response to increases and decreases in supply line 170 fluid pressure, respectively. Thus, when fluid pressure increases in the supply line 170, the floor 161 of the flow channel 150 is pressed-up or deflected up into the flow channel 150 thereby reducing the cross-section of the flow channel to regulate the flow of fluid through the emitter 10. Conversely, when fluid pressure in the supply line 170 reduces, the floor of the flow channel 150 retreats from the flow channel back to a normal position wherein the floor is not deflected up into the flow channel thereby increasing the cross-section of the flow channel to allow fluid to flow more freely through the flow channel 150.

The second part of the pressure compensation mechanism 160 comprises a movable structure, such as movable baffle portion 162, which is capable of moving between a first low pressure position wherein the length of the flow channel 150 is of a first distance and a second high pressure position wherein the length of the flow channel 150 is of a second distance wherein the length of the flow channel is longer than the first distance to compensate for increase pressure in the supply line 170. More particularly, in the form illustrated, the movable baffle portion 162 deflects up and down with the floor of the flow channel 150 to sealingly engage and disengage the movable baffle portion 162 with the inner wall of the supply line 170, respectively, and thereby lengthen or shorten the extent of the flow channel for at least some fluid flowing therethrough to compensate for changes in supply line fluid pressure.

The movable baffle portion 162 comprises a tapered portion of the central or inner baffle wall 151 that tapers down away from the inner surface of supply line 170 so that at lower fluid pressures in supply line 170, fluid flows through the inlet 130 and first section (or upstream section) of flow channel 150 and then over the top of the tapered baffle section 162, through the second section (or downstream section) of the flow channel 150 and then into the outlet pool 140. Fluid may flow through the remaining portion of the flow channel 150 including intermediate bath 153 (located between the upstream and downstream sections of the flow channel 150), but it does not have to nor does all of the fluid flow through these portions of the flow channel 150 due to the gap between the upper surface of the tapered inner baffle wall section 152 and the inner surface of tube 170. As fluid pressure increases in the fluid supply line 170, the floor of the flow channel 150 starts to deflect upwards and into the flow channel 150 moving the tapered baffle section 162 toward the inner surface of tube 170 thereby reducing the gap between these two until the upper surface of the tapered baffle section 162 sealingly engages the inner wall of the tube 170 thereby preventing fluid from flowing over the top of the tapered baffle section 162 and lengthening the amount of the flow channel 150 through which all of the fluid must flow and reducing fluid pressure and flow due to same.

Since the emitter 100 is made of an integral body 120, the outlet area 140 is provided with obstructions or stops, such as posts or nubs 141, that prevent the outlet are 140 from collapsing when the fluid pressure of supply line 170 raises to a level sufficient for deflecting the floor of the flow channel 150 into the flow channel 150 to reduce the cross-section of same and regulate fluid flow through the flow channel. The outlet tube 180 is centered between the posts 141. The fluid enters the outlet area 140 and flows into the tube 180 through one or more inlets 181. The fluid travels through the tube 180 and exits through an opening 182 of the tube outside the dripline. Alternatively, the exit tube 180 could be added after the emitter is installed in the dripline 170. For example, the dripline 170 could be drilled over the outlet bath 140, and the exit tube 180 could be inserted and mechanically attached and or welded or glued to the dripline 170, such as that shown in FIG. 3A. In another alternative embodiment, the outlet tube 180 could be positioned over the outlet of the tortuous path 150, such as that shown in FIG. 3B.

Further disclosure of this embodiment as well as other drip emitter embodiments that may be used with the outlet tube 12 are disclosed in U.S. application Ser. No. 13/430,249, which is incorporated by reference herein.

Alternatively, the emitter just described could be made of a rigid material. In this case, the emitter would not be pressure compensating, and there may not be a tapered portion of the baffles. It also may not need the posts 141 in the outlet area 140. Otherwise, the emitter would generally be the same.

While the foregoing description is with respect to specific examples, those skilled in the art will appreciate that there are numerous variations of the above that fall within the scope of the concepts described herein and the appended claims.

What is claimed is:

1. A dripline comprising:
a supply tube with a tube wall having an inside surface and an outside surface;
at least one emitter mounted to the inside surface of the supply tube; and
an outlet tube communicating with the emitter and extending through the tube wall and a predetermined distance away from the outside surface of the supply tube.

2. The dripline of claim 1 wherein the outlet tube extends radially from the outside surface of the supply tube.

3. The dripline of claim 1 wherein the outlet tube extends at least 0.125 inches from the outside surface of the supply tube.

4. The dripline of claim 1 wherein the outlet tube extends at least 0.5 inches from the outside surface of the supply tube.

5. The dripline of claim 1 wherein the outlet tube is cylindrical.

6. The dripline of claim 1 where the outlet tube has at least one barb.

7. The dripline of claim 1 wherein the drip emitter is pressure compensating.

8. The dripline of claim 1 wherein the drip emitter is a single piece emitter.

9. The dripline of claim 8 wherein the drip emitter is pressure compensating.

10. The dripline of claim 9 wherein the drip emitter is of elastomeric material.

11. The dripline of claim 1 wherein an outer surface of the outlet tube has ribs.

12. The dripline of claim 1 wherein an outer surface of the outlet tube is textured.

13. The dripline of claim 1 wherein the outlet tube is supported by the at least one emitter.

14. The dripline of claim 1 wherein the outlet tube is supported by the supply tube at the at least one emitter.
